(19) United States
(12) Patent Application Publication
(10) Pub. No.: US 2014/0019174 A1
(43) Pub. Date: Jan. 16, 2014

(54) SYSTEMS AND METHODS FOR MANAGING PARKING SPACES

(71) Applicant: Dhaval T. BHATT, Anaheim, CA (US)

(72) Inventor: Dhaval T. BHATT, Anaheim, CA (US)

(21) Appl. No.: 13/904,546

(22) Filed: May 29, 2013

Related U.S. Application Data
(60) Provisional application No. 61/670,113, filed on Jul. 10, 2012.

(51) Int. Cl. G06Q 10/02

(52) U.S. Cl. CPC G06Q 10/02
USPC 705/5

(57) ABSTRACT

Systems and methods for managing parking spaces. A method is provided that includes receiving parking information for a user that includes a parking structure and an arrival time or departure time of the user at the parking structure. The method further includes comparing the received parking structure and the arrival time or departure time of the user to parking information of another user that includes a parking structure and an arrival time or departure time of the another user at the parking structure. If the parking structure and the arrival time or departure time of the user match up with the parking structure and the arrival time or departure time of the another user, then providing contact information of the another user to the user.

### CROSS REFERENCE TO RELATED APPLICATION

The present invention claims priority to U.S. Provisional Application No. 61/670,113, filed on Jul. 10, 2012, the contents of which are incorporated by reference in their entirety herein.

### FIELD OF THE INVENTION

The present invention generally relates to parking management, and more particularly, to methods and systems for managing vehicle parking spaces using a parking partner registration process.

### BACKGROUND

Vehicle parking spaces are becoming one of the scarcest resources on college or university campuses, at the workplace, and even at the local shopping center. This scarcity is commonly classified as an urban transportation problem and handled using urban planning techniques. For example, two common urban planning techniques for managing parking spaces include political and economic approaches. The political approach relies on administrative rules that allocate parking according to status and need, while the economic approach relies on markets of supply and demand.

More advanced urban planning techniques combine political and economic approaches with computerized means for locating and reserving parking spaces prior to arrival. For example, some parking garages implement a workspace management system that is configured to automatically manage parking spots using a check-in and check-out process much like a library manages its book collection such that the system is able to indicate which parking spaces are open, designate which parking spaces are currently being used, and which parking spaces are reserved for future use. In some instances, the workspace management systems can be accessed using a remote application, for example a user's smart phone, such that the user may locate and reserve available parking spots prior to arrival. However, in many instances, for example in instances of public parking and parking lots/garages that do not implement workspace management systems, these urban planning techniques have failed to provide a stress free easy access environment for parking vehicles.

Accordingly, there exists a need in the art to overcome the deficiencies and limitations described above.

### SUMMARY

In a first aspect of the invention, a method is provided that is implemented in a computer infrastructure. The method includes receiving parking information for a user comprising at least one parking structure and at least one arrival time or departure time of the user at the at least one parking structure. method further includes comparing the received at least one parking structure and the at least one arrival time or departure time of the user to parking information of at least one other user comprising at least one parking structure and at least one arrival time or departure time of the at least one other user at the at least one parking structure. The method further includes providing contact information of the at least one other user to the user, when the at least one parking structure and the at least one arrival time or departure time of the user match up with the at least one parking structure and the at least one arrival time or departure time of the at least one other user such that the user is either arriving at the at least one parking structure at a time similar to a time at which the at least one other user is departing the at least one parking structure, or the user is departing the at least one parking structure at a time similar to a time at which the at least one other user is arriving at the at least one parking structure.

In another aspect of the invention, a system implemented in hardware is provided including a parking tool implemented on a processor and configured to receive parking information for a user comprising at least one parking structure and at least one arrival time or departure time of the user at the at least one parking structure. The parking tool further configured to compare the received at least one parking structure and the at least one arrival time or departure time of the user to parking information of at least one other user comprising at least one parking structure and at least one arrival time or departure time of the at least one other user at the at least one parking structure. The parking tool further configured to provide contact information of the at least one other user to the user, when the at least one parking structure and the at least one arrival time or departure time of the user match up with the at least one parking structure and the at least one arrival time or departure time of the at least one other user such that the user is either arriving at the at least one parking structure at a time similar to a time at which the at least one other user is departing the at least one parking structure, or the user is departing the at least one parking structure at a time similar to a time at which the at least one other user is arriving at the at least one parking structure.

In an additional aspect of the invention, a computer program product including a computer readable storage medium having readable program code embodied in the medium is provided. The computer program product includes at least one component operable to receive parking information for a user comprising at least one parking structure and at least one arrival time or departure time of the user at the at least one parking structure. The at least one component further operable to compare the received at least one parking structure and the at least one arrival time or departure time of the user to parking information of at least one other user comprising at least one parking structure and at least one arrival time or departure time of the at least one other user at the at least one parking structure. The at least one component further operable to provide contact information of the at least one other user to the user, when the at least one parking structure and the at least one arrival time or departure time of the user match up with the at least one parking structure and the at least one arrival time or departure time of the at least one other user such that the user is either arriving at the at least one parking structure at a time similar to a time at which the at least one other user is departing the at least one parking structure, or the user is departing the at least one parking structure at a time similar to a time at which the at least one other user is arriving at the at least one parking structure.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 shows an illustrative environment for implementing processing steps in accordance with aspects of the invention;

FIG. 2 shows an illustrative environment for implementing processing steps in accordance with aspects of the invention;

FIG. 3 shows an exemplary flow in accordance with aspects of the invention;

FIGS. 4a-4d shows exemplary screen shots in accordance with aspects of the invention; and

FIG. 5 shows an exemplary swim lane diagram in accordance with aspects of the present invention.

### DETAILED DESCRIPTION

The present invention generally relates to parking management, and more particularly, to methods and systems for managing vehicle parking spaces using a parking partner registration process. According to aspects of the invention, a parking management system provides users with functionality to set up an account including vehicle parking parameters or requirements, determine at least one parking partner based on the vehicle parking parameters or requirements, and provide identification of the determined at least one parking partner to the user such that the user and the at least one parking partner may coordinate their schedules to enable efficient use of vehicle parking spaces (e.g., vehicle parking spaces located on college or university campuses, at the workplace, and/or at a shopping center).

In some embodiments, the present invention is directed to a tool or web based application configured to create efficiency in parking. For example, a user may utilize the tool or web based application to generate an account profile that includes vehicle parking parameters or requirements (e.g., a request for a parking space in a parking structure from time “x” to time “y”). The tool or web based application may be further configured to determine at least one parking partner that plans on removing their vehicle from a parking space in the parking structure at or near time “x”, and/or determining at least one parking partner that plans on parking their vehicle at a parking space in the parking structure at or near time “y”. The tool or web based application may further be configured to facilitate a parking arrangement between the user and the determined at least one parking partner such that the user may arrive at or near time “x” in the parking structure and obtain the parking spot from the determined at least one parking partner who is removing their vehicle from the parking spot at or near time “x”, and/or such that the at least one parking partner may arrive at or near time “y” in the parking structure and obtain the parking spot from the user who is removing their vehicle from the parking spot at or near time “y”

Advantageously by providing these parking functionalities in real-time and pairing parking partners with the ability to communicate parking information to each other in real-time via the tool or web based application, the methods and systems of the present invention help to facilitate better efficiency in vehicle parking in ways that previous systems and methods have not attempted.

### System Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium and/or device. A computer readable storage medium and/or device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium and/or device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium and/or device may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

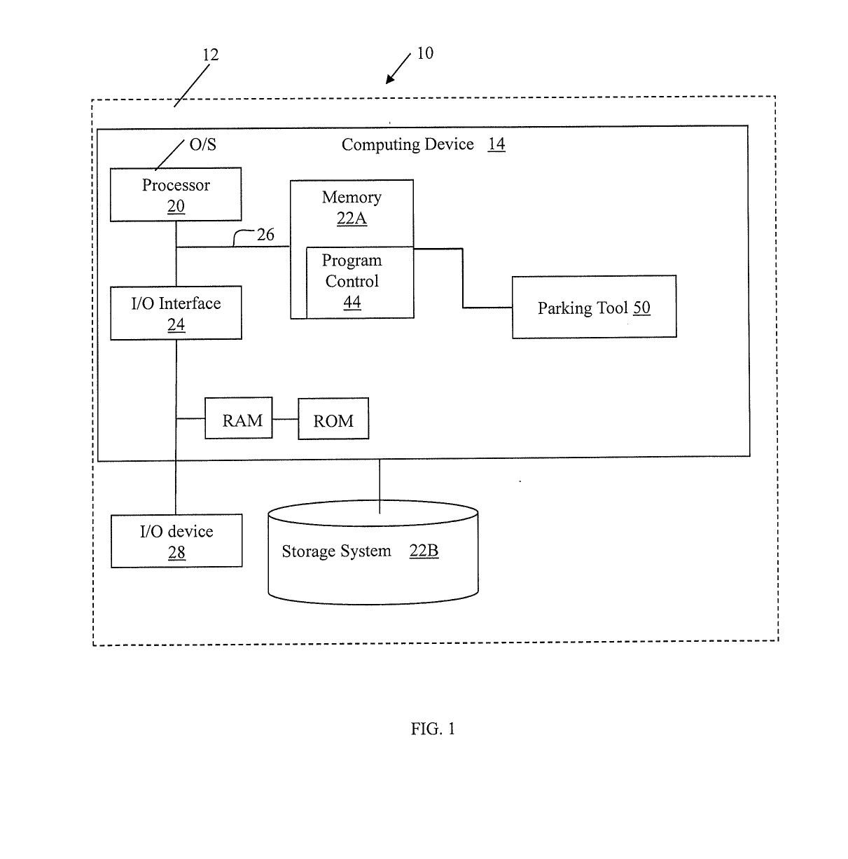

FIG. 1 shows an illustrative environment 10 for managing the processes in accordance with the invention. To this extent, environment 10 includes a server or other computing system 12 that can perform the processes described herein. In particular, server 12 includes a computing device 14. The computing device 14 can be resident on a network infrastructure or computing device of a third party service provider (any of which is generally represented in FIG. 1).

The computing device 14 also includes a processor 20, memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with external I/O device/resource 28 and storage system 22B. For example, I/O device 28 can comprise any device that enables an individual to interact with computing device 14 (e.g., user interface) or any device that enables computing device 14 to communicate with one or more other computing devices using any type of communications link. The external I/O device/resource 28 may be for example, a handheld device, PDA, handset, keyboard etc.

In general, processor 20 executes computer program code (e.g., program control 44), which can be stored in memory 22A and/or storage system 22B. Moreover, in accordance with aspects of the invention, program control 44 controls a parking tool 50, e.g., the processes described herein. The parking tool 50 can be implemented as one or more program code in program control 44 stored in memory 22A as separate or combined modules. Additionally, the parking tool may be implemented as separate dedicated processors or a single or several processors to provide the function of these tools. While executing the computer program code, the processor 20 can read and/or write data to/from memory 22A, storage system 22B, and/or I/O interface 24. The program code executes the processes of the invention. The bus 26 provides a communications link between each of the components in computing device 14.

The computing device 14 can comprise any general purpose computing article of manufacture capable of executing computer program code installed thereon (e.g., a personal computer, server, etc.). However, it is understood that computing device 14 is only representative of various possible equivalent-computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, computing infrastructure 12 is only illustrative of various types of computer infrastructures for implementing the invention. For example, in embodiments, server 12 comprises two or more computing devices (e.g., a server cluster) that communicate over any type of communications link, such as a network, a shared memory, or the like, to perform the process described herein. Further, while performing the processes described herein, one or more computing devices on server 12 can communicate with one or more other computing devices external to server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

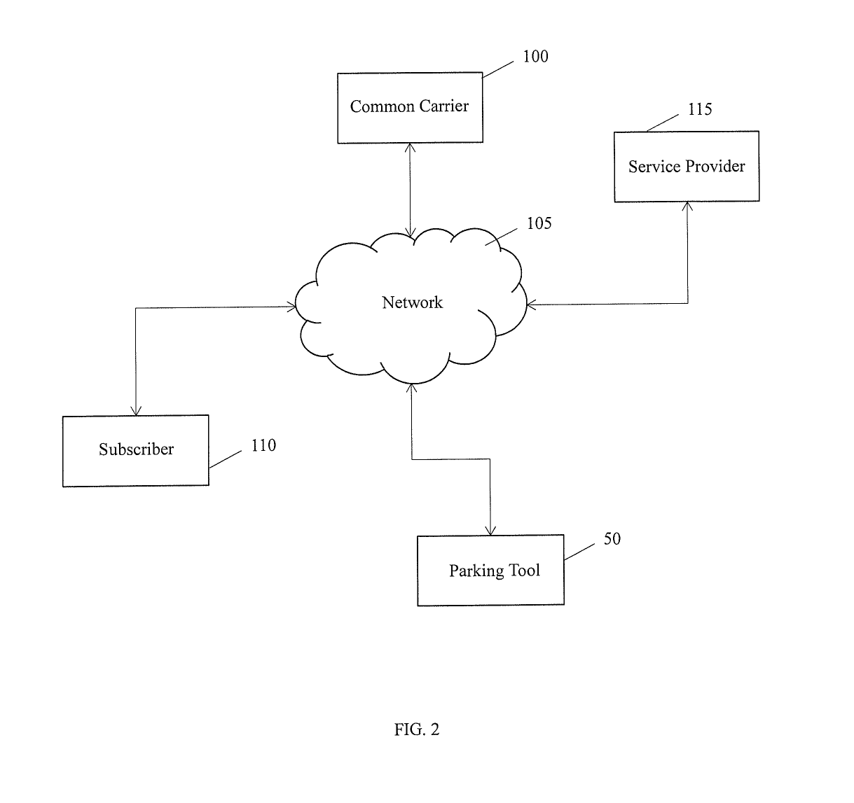

FIG. 2 shows an exemplary context suitable for application of the present invention. As shown in FIG. 2, a common carrier 100 provides communication service over a public network 105 connecting a subscriber or user 110 (e.g., a mobile device of a subscriber or user), a service provider 115 (e.g., a server of the service provider), and a parking tool 50. In embodiments, the parking tool 50 is a program or module (as described above with respect to FIG. 1) provided by the service provider 115 that is downloaded or accessed via a computing device 14 (as described above with respect to FIG. 1) of the subscriber or user 110. In embodiments, the user may install and/or configure the parking tool 50 directly on the user's computing device 14 or the user may access the parking tool 50 indirectly using the user's computing device 14, e.g., the parking tool 50 may be accessed via cloud computing. For example, the user may access the parking tool 50 (i.e., a cloud application) through a web browser or a light-weight desktop or mobile application while the business software and user's data are stored on servers at a remote location.

Only one subscriber or user 110 and one corresponding parking tool 50 are shown in the interest of descriptive clarity; however, the invention applies, of course, to any number of subscribers or users 110 and corresponding parking tool 50. As should be understood by one of ordinary skill in the art, the common carrier 100 and the service provider 115 may be the same entity in accordance with aspects of the present invention.

In this example, which will be used throughout to illustrate but not limit the present invention, the common carrier 100 may be, for example, a provider of cellular telephone service who offers wireless internet access. The subscriber or user 110 may be, for example, a consumer (e.g., any business or person that uses technology) who establishes a service account with the common carrier 100 for the purpose of accessing the Internet, and who establishes a service account with the service provider 115 for the purpose of parking assist services such as access to potential parking partner matching and vehicle parking spot identifying functionality provided by the parking tool 50.

The service provider 115 may be a Solution Integrator that offers to perform the processes described herein. In embodiments, the service provider 115 can create, maintain, deploy, support, etc., the computer infrastructure that performs the process steps of the invention for one or more subscribers 110 (e.g., users). For example, the service provider 115 can deploy the parking tool 50 program or module. In return, the service provider 115 can receive payment from the subscriber(s) 110 under a subscription and/or fee agreement and/or the service provider 115 can receive payment from the sale of advertising content to one or more third parties.

The service provider 115 gathers information from the subscriber or user 110. This information may be gathered at the time the subscriber or user 110 signs on for service with the service provider 115. As part of establishing a service account, the service provider 115 may provide the subscriber or user 110 with access to the parking tool 50. In embodiments, the parking tool 50 may be configured to receive profile information of the subscriber or user 110, and use the profile information to determine potential parking partners and/or available vehicle parking spots. For example, in accordance with aspects of the invention, the parking tool 50 can set up an account for a user including vehicle parking parameters or requirements, determine at least one parking partner based on the vehicle parking parameters or requirements, and provide the determined at least one parking partner to the user such that the user and the at least one parking partner may coordinate their schedules to enable efficient use of vehicle parking spaces.

### Flow Diagram

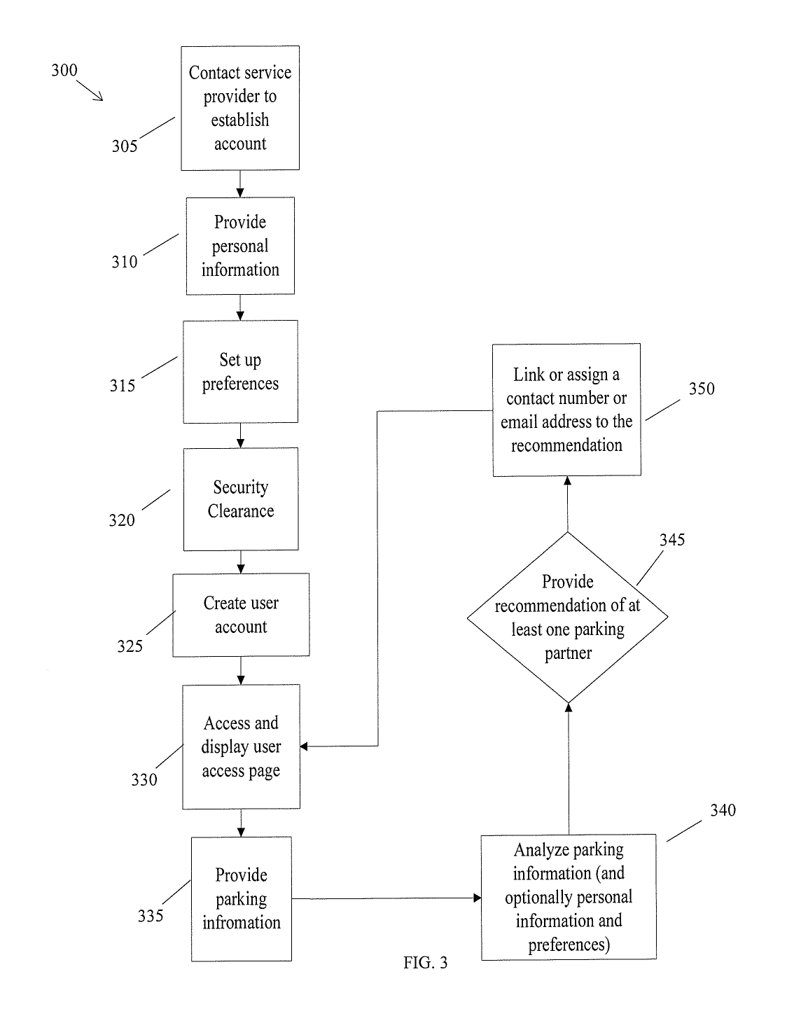

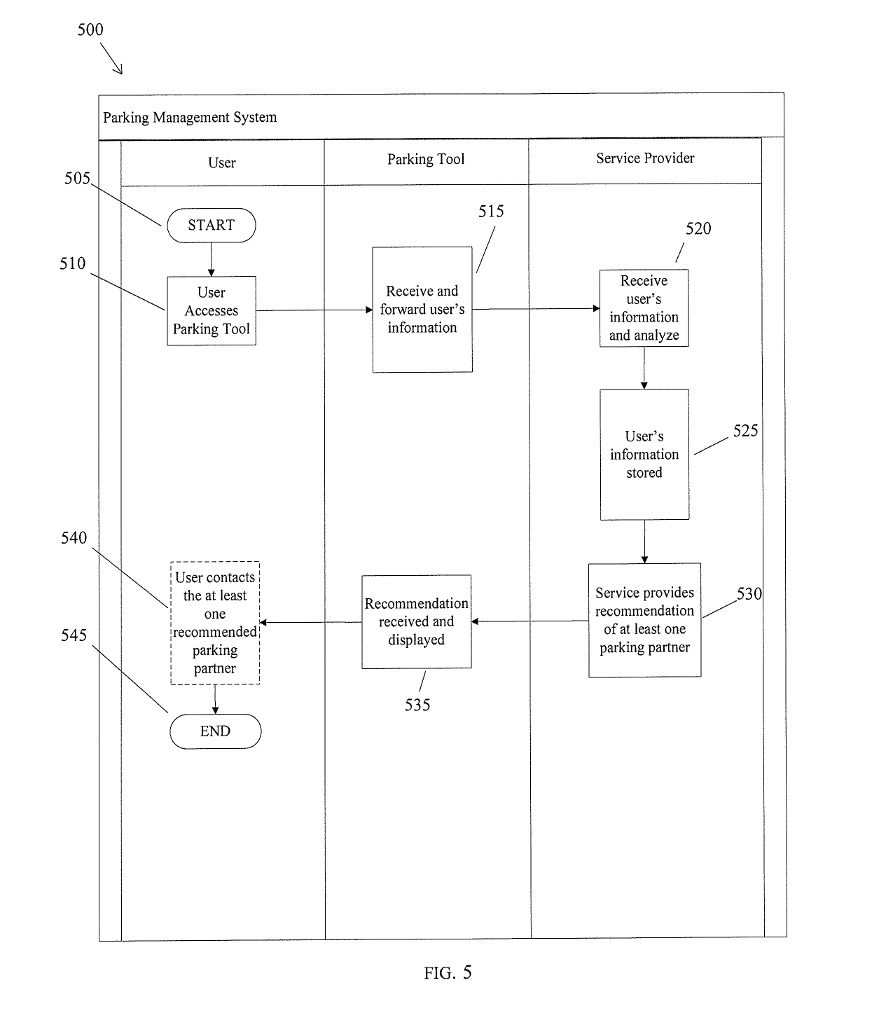

FIGS. 3 and 5 show exemplary flows for performing aspects of the present invention. The steps of FIGS. 3 and 5 may be implemented in the environments of FIGS. 1 and 2, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, the invention can take the form of a computer program product accessible from a computer readable storage medium and/or device providing program code for use by or in connection with a computer or any instruction execution system. The software and/or computer program product can be implemented in the environments of FIGS. 1 and 2

Hereafter embodiments of the present invention are discussed with respect to a parking tool 50 configured to provide parking assistance to students on a college or university campus attending school. However, it should be understood by one skilled in the art that aspects of the present invention including the parking tool 50 may be implemented using any type of user (e.g., employees) interested in finding a parking partner for parking spaces located in any parking structure (e.g., a parking space located at work).

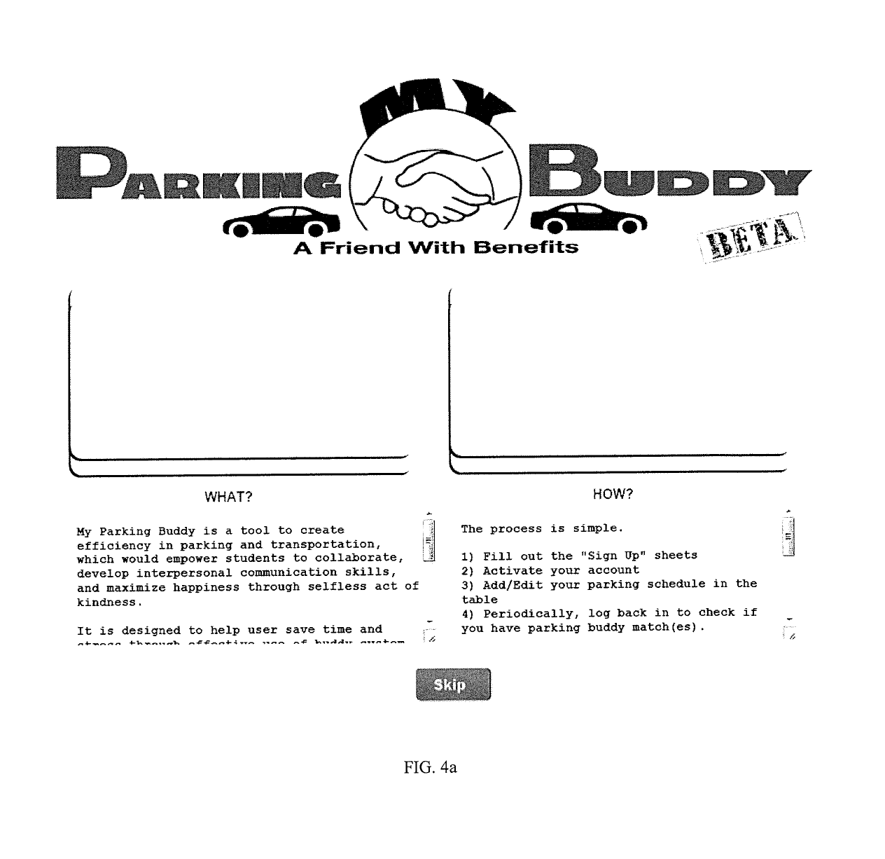

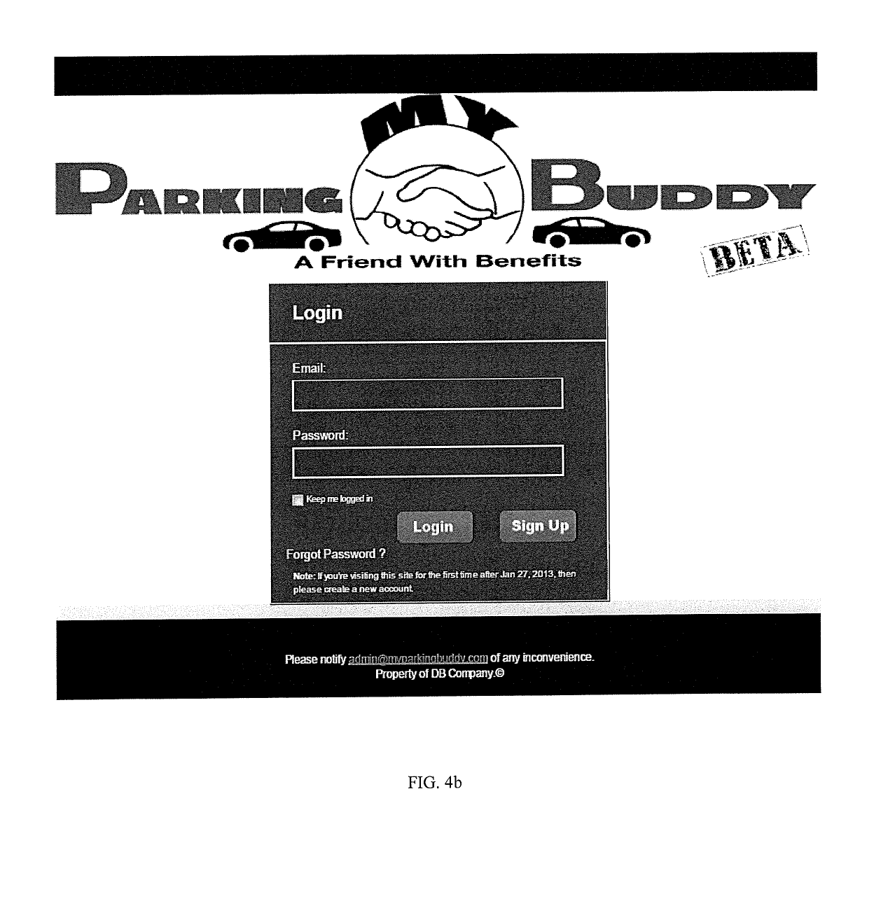

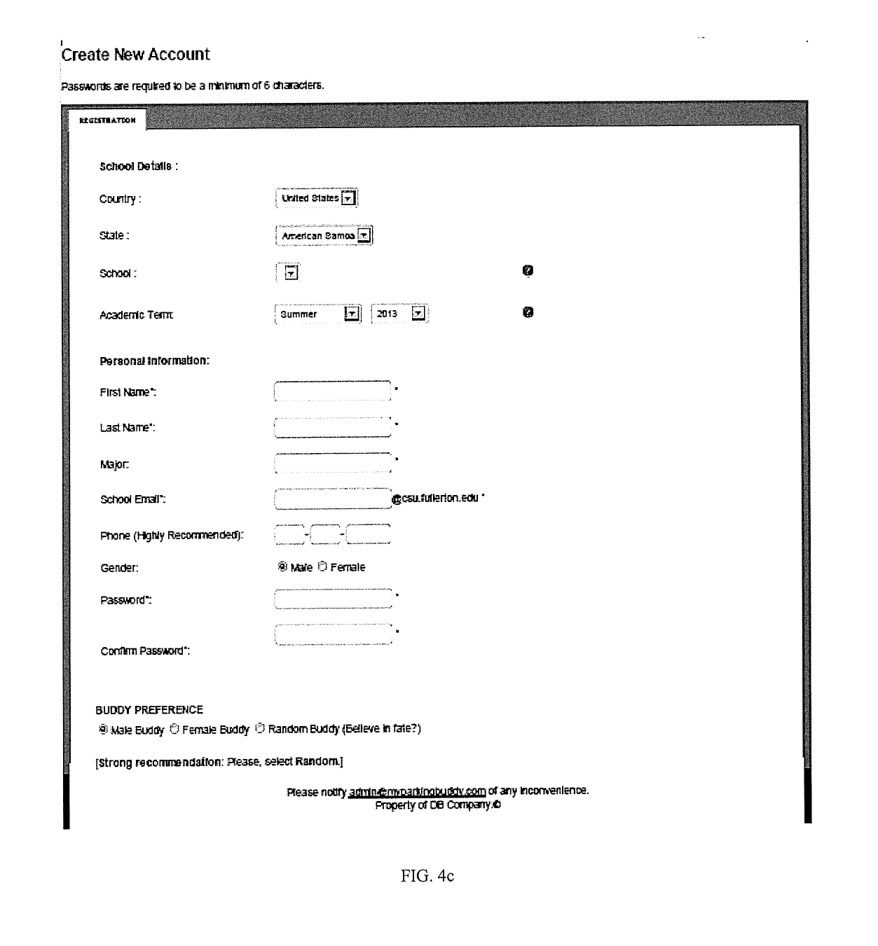

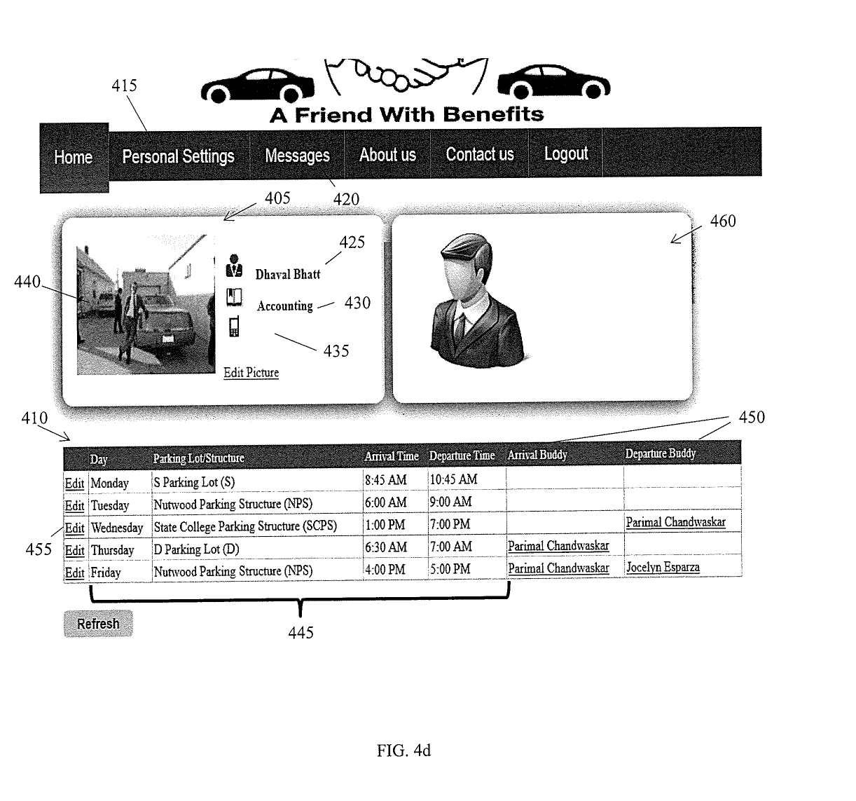

FIG. 3 depicts an exemplary flow 300 for a process of establishing service for use of the parking management system and use thereof in accordance with aspects of the present invention. As shown in FIG. 3, the process may start at step 305 where the user may contact the service provider to establish a service account. For example, the user may access a web page (e.g., a web page comprising parking tool 50 as discussed above with reference to FIGS. 1 and 2) of the service provider (as shown in FIG. 4a), and initiate a new account and log in process configured to establish the service (as shown in FIG. 4b).

Optionally in some embodiments, establishing the service account may comprise the user downloading or obtaining the parking management system (e.g., parking tool 50 as discussed above with reference to FIGS. 1 and 2) as a software tool. For example, the parking management system may be downloaded as a software application for a mobile device. Thereafter, the user may initiate a new account and log in process configured to establish the service (as shown in FIG. 4b) similar to the process described above with respect to the user accessing a web page of the service provider.

At step 310, at this time, or later in preparation, the service provider may collect elements of personal information about the user. For example, the service provider may utilize a form page such as the web page shown in FIG. 4c to collect personal information about the user. Exemplary elements of personal information may include name, home address, country, state/province, university or college campus, academic term, work address, date of birth, gender, major or occupation, email, username and/or password, method of payment, contact information (i.e., mobile device number), vehicle information (e.g., type of vehicle and driver's license number), and a wide variety of other personal related information. Although aspects of the initiation of a new account is described here in the context of written language that may be displayed to the user via the web page or software application of the service provider, the elements of personal information are not so limited, and may also include special characters, images, pointers to other information such as uniform resource locators, and so forth.

Optionally at step 315, at this time, or later, or earlier in preparation, the user may set up and manage user preferences for the parking tool 50. In embodiments, the preferences set and edited may include by non-limiting example: preferences for finding a parking partner such as whether a parking partner is to be a male, female, or random, and/or have a profile that includes a certain major or occupation, and/or user provided rating.

At step 320, upon establishment of the service account including providing the personal information and optionally setting up the user preferences, the service provider may request that the user activate their account by way of, for example, an activation link. In accordance with these aspects of the invention, the activation of the account may act as a security clearance in order for the service provider to filter out users they may not wish to grant a service account. In embodiments, the activation link may be sent as a notification to the user's email provided in the personal information.

At step 325, the new account to establish the service may be granted and created by the parking management system using the input personal information and optionally the user preferences provided during the initiation of the new account and log in process. For example, upon the user activating their account, the new account to establish the service may be granted and generated using the input personal information and optionally the user preferences provided during the initiation of the new account and log in process.

At step 330, the user may access the new account and a user access page may be displayed to the user by the parking management system. In some embodiments, as shown in FIG. 4d, the user access page may provide user information such as a user profile 405 and a parking listing 410, and a graphical user interface (GUI) that is configured to provide the user with access to additional functionality of the parking management system including access to personal settings 415 and an internal messaging service 420.

In some embodiments, the user profile 405 may be populated with data using the input personal information. For example, as shown in FIG. 4d, the user profile 405 may include the user's name 425, occupation and/or major 430, and contact information 435. In additional embodiments, the user profile 405 may further include an editable picture 440. In accordance with some aspects of the present invention, the user profile 405 may include the personal information that is shared between the user and the potential arrival and/or departure parking partners in order to create a parking partnership using the parking management system.

In some embodiments, the listing 410 may be populated using parking information (as discussed in detail below). For example, as shown in FIG. 4d, the listing 410 may include the user's commuting or parking schedule 445 including any potential and/or actual arrival and/or departure parking partners 450. In additional embodiments, the listing 410 may further include at least one edit button 455 for modifying the user's parking information.

In some embodiments, the user may access their personal settings 425, and edit their personal information and optionally their user preferences. For example, the user may access a page similar to that shown in FIG. 4c, which is configured to allow the user to edit and save changes to their personal information and optionally their user preferences. As should be understood, any changes made and saved to the personal settings 425 may then be implemented and displayed within the user profile 405 and the listing 410.

In some embodiments, the user may access an internal messaging service 430, and send or receive messages to or from other users (e.g., potential and/or archived arrival and/or departure parking partners as discussed in further detail below). The internal messaging service may be a separate form of communication from that of the user's personal email in order to maintain privacy of the users. For example, the internal messaging service may comprise an inbox, outbox, and message composer for generating, sending, and receiving messages internal to the parking management system.

At step 335, at this time, or later, or earlier in preparation, the service provider may collect elements of parking information. For example, the use may input parking information using the at least one edit button 455, as shown in FIG. 4d, or the parking tool 50 may be configured to request elements of parking information from the user similar to the process for requesting personal information, as described herein. Exemplary elements of parking information may include location information such as parking structures in which the user may be interested in parking, global positioning system (GPS) information for the user's current location and/or location of the parking structure or parking space, time frame in which the user intends to use a parking space located within the parking structure (e.g., arrival time and departure time), and a wide variety of other parking information. Although aspects of the collection of parking information is described here in the context of written language that may be displayed to the user via the web page or software application of the service provider, the elements of parking information are not so limited, and may also include special characters, images, pointers to other information such as uniform resource locators, and so forth. For example, the user may be able to upload a class schedule to the parking tool 50 as parking information that includes time frames in which the user intends to use a parking space located on a college or university campus (e.g., the times in which the student is in class).

At step 340, the user's parking information (and optionally personal information and user preferences) may be analyzed by the parking management system. In embodiments, the parking tool 50 may operate independent of or in conjunction with the service provider (e.g., forwarding the user's parking information (and optionally personal information and user preferences) to the service provider) to analyze the user's parking information (and optionally personal information and user preferences). For example, the parking tool 50 and/or service provider may determine and generate the following information as shown in Table 1:

TABLE 1

| (Monday) | User1 | User2 | User3 |
|---|---|---|---|
| In | 8:00 am | 10:15 am | 12:30 pm |
| Out | 10:30 am | 12:30 pm | 2:00 pm |
| Arrival Partner | None | User1 | User2 |
| Departure Partner | User2 | User3 | None |
| Parking | East Side Parking | East Side Parking | East Side |
| Lot/Structure | Str | Str | Parking Str |

In accordance with some aspects of the present invention, the parking tool 50 and/or service provider may determine and generate the information of Table 1 using an algorithm. For example, the algorithm may utilize input variable(s) such as the user's parking information (and optionally personal information and user preferences) to determine and generate the information of Table 1. Exemplary elements of the algorithm may include Country (USA)-->State (CA)--->City (Fullerton)--->University/Community College (California State University, Fullerton)--->Academic Term (optionally may include Start and End Date of the Academic Term)--->Parking Lot/Structure-->[(15 minutes to 0 minutes)Arrival/Departure Time+Monday through Friday]-->Optionally a Partner Preference (Male Partner, Female Partner, or Random Partner)-->security clearance===(End Result=Partner matching).

In embodiments, the algorithm may be configured to compare the variable(s) (e.g., the user's parking information (and optionally personal information and user preferences)) to a portion or all of the parking information (and optionally personal information and user preferences) of other users registered with the parking management system to obtain the information of Table 1 including the identification of other users that have departure times that match up with the arrival times of the user, and arrival times that match up with the departure times of the user. The parking information (and optionally personal information and user preferences) of the other users may be collected (e.g., collected by the service provider) and stored within the system (e.g., within storage system 22B). In some embodiments, the departure and arrival times may comprise a modifiable range (e.g., 15-0 minutes) in order to provide some flexibility as to when the various users may be arriving or departing the parking spot.

At step 345, the parking tool 50 and/or service provider may recommend to the user at least one potential parking partner (e.g., arrival partner and/or departure partner 450 as shown in FIG. 4d) up to a maximum number of potential parking partners (e.g., 28) based on the analysis of the user's parking information (and optionally personal information and user preferences). In some embodiments, the parking tool 50 and/or service provider may generate a list of a top number (e.g., 10) of potential parking partners that may be departing and/or arriving at a parking spot during at least one arrival time and/or departure time of the user. For example, using the information of Table 1, the parking tool 50 and/or service provider may be configured to generate a list of potential parking partners for a user 1 that includes the user 2 as a potential departure parking partner on Monday at 10:30 am. Moreover, the parking tool 50 and/or service provider may be configured to generate a list of potential parking partners for a user 2 that includes the user 1 as a potential arrival parking partner on Monday at 10:15 am and user 3 as a potential departure parking partner on Monday at 12:30 pm. Furthermore, the parking tool 50 and/or service provider may be configured to generate a list of potential parking partners for a user 3 that includes the user 2 as a potential arrival parking partner on Monday at 12:30 pm.

At step 350, a user profile (e.g., similar to the user profile 405 shown in FIG. 4d) may be linked or assigned to each of the at least one potential parking partners such that the user may contact (e.g., use their mobile device to contact) each of the at least one potential parking partners to establish parking partner relationships. For example, the names of each of the least one potential parking partners (e.g., arrival partner and/or departure partner 450 as shown in FIG. 4d) displayed in listing 410 may be configured as a hyper link such that clicking on the names of each of the least one potential parking partners displays a linked or assigned user profile 460 comprising contact information for each of the least one potential parking partners, as shown in FIG. 4d. This allows the user to facilitate a parking arrangement between the user and the determined at least one parking partner such that the user may arrive or depart at or near time “x” in the parking structure and obtain or release the parking spot from or to the determined at least one parking partner who is removing or arriving with their vehicle from the parking spot at or near time “x.”.

In some embodiments, the parking tool 50 and/or service provider may include the personal contact number and/or email address of each of the at least one potential parking partners in the user profiles linked or assigned to each of the at least one potential parking partners. In additional or alternative embodiments, the parking tool 50 and/or service provider may include an internal message link for each of the at least one potential parking partners in the user profile linked or assigned to each of the at least one potential parking partners such that the user may utilize the internal message system 420 (as shown in FIG. 4b) to contact each of the at least one potential parking partners. In additional embodiments, the parking tool 50 and/or service provider may archive the contact information (e.g., the personal contact number and/or email address or the internal message link of each of the at least one potential parking partners) in storage (e.g., storage system 22B) accessible by the user such that the user may contact each of the at least one potential parking partners at another time (e.g., at a later date with respect to social aspects of the present invention).

Advantageously by providing these parking functionalities in real-time and pairing parking partners with the ability to communicate parking information to each other in real-time via the tool or web based application, the methods and systems of the present invention help to facilitate better efficiency in vehicle parking in ways that previous systems and methods have not attempted.

FIG. 5 depicts an exemplary swim lane diagram 500 showing processing steps in accordance with aspects of the present invention. More specifically, FIG. 5 shows a flow for a process of establishing service for use of the parking management system and determining at least one potential parking partner in accordance with aspects of the invention, with three players: a subscriber or user, parking tool 50, and a service provider. As shown in FIG. 5, at step 505, the registration process starts. At step 510, the registration process may be initiated by the user accessing, downloading, installing, and/or configuring the parking tool 50 on a computing device. At step 515, the parking tool 50 receives the user's information (e.g., personal information and parking information, and optionally user preferences), and routes a parking service request and the user's information to the service provider.

At step 520, the service provider receives and analyzes the parking service request and the user's information. At step 525, the service provider stores the user's information. In embodiments, the user's information may be stored locally or remotely. At step 530, the service provider recommends to the user at least one potential parking partner based on the analysis of the parking service request, the user's information, and part or all of the information (e.g., personal information and parking information, and optionally user preferences) stored for other user's of the parking management system, and forwards the recommendation to the parking tool 50. At step 535, the parking tool 50 receives and displays the recommended at least one potential parking partner. Optionally at step 540, the user contacts the at least at least one potential parking partner. At step 545, the process ends.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method implemented in a computer infrastructure, the method comprising:
receiving parking information for a user comprising at least one parking structure and at least one arrival time or departure time of the user at the at least one parking structure;
comparing the received at least one parking structure and the at least one arrival time or departure time of the user to parking information of at least one other user comprising at least one parking structure and at least one arrival time or departure time of the at least one other user at the at least one parking structure; and
when the at least one parking structure and the at least one arrival time or departure time of the user match up with the at least one parking structure and the at least one arrival time or departure time of the at least one other user such that the user is either arriving at the at least one parking structure at a time similar to a time at which the at least one other user is departing the at least one parking structure, or the user is departing the at least one parking structure at a time similar to a time at which the at least one other user is arriving at the at least one parking structure, then providing contact information of the at least one other user to the user.

2. The method of claim 1, further comprising receiving personal information of the user, wherein the comparing further comprises comparing the personal information of the user to personal information of the at least one other user.

3. The method of claim 2, wherein when the personal information, the at least one parking structure, and the at least one arrival time or departure time of the user match up with the personal information, the at least one parking structure, and the at least one arrival time or departure time of the at least one other user, then provide the contact information of the at least one other user to the user.

4. The method of claim 3, wherein the personal information is a college or university at which the user and the at least one other user attend school.

5. The method of claim 1, further comprising receiving at least one preference of the user, wherein the comparing further comprises comparing the at least one preference of the user to at least one preference of the at least one other user.

6. The method of claim 5, wherein when the at least one preference, the at least one parking structure, and the at least one arrival time or departure time of the user match up with the at least one preference, the at least one parking structure, and the at least one arrival time or departure time of the at least one other user, then provide the contact information of the at least one other user to the user.

7. The method of claim 6, wherein the at least one preference of the user and the at least one other user is a gender preference.

8. The method of claim 1, wherein a service provider at least one of creates, maintains, deploys and supports the computer infrastructure.

9. The method of claim 1, wherein steps of claim 1 are provided by a service provider on a subscription, advertising, and/or fee basis.

10. A system implemented in hardware, comprising:
a parking tool implemented on a processor and configured to:
receive parking information for a user comprising at least one parking structure and at least one arrival time or departure time of the user at the at least one parking structure;
compare the received at least one parking structure and the at least one arrival time or departure time of the user to parking information of at least one other user comprising at least one parking structure and at least one arrival time or departure time of the at least one other user at the at least one parking structure; and
when the at least one parking structure and the at least one arrival time or departure time of the user match up with the at least one parking structure and the at least one arrival time or departure time of the at least one other user such that the user is either arriving at the at least one parking structure at a time similar to a time at which the at least one other user is departing the at least one parking structure, or the user is departing the at least one parking structure at a time similar to a time at which the at least one other user is arriving at the at least one parking structure, then provide contact information of the at least one other user to the user.

11. The system of claim 10, wherein the parking tool is further configured to receive personal information of the user, and the comparing further comprises comparing the personal information of the user to personal information of the at least one other user.

12. The system of claim 11, wherein when the personal information, the at least one parking structure, and the at least one arrival time or departure time of the user match up with the personal information, the at least one parking structure, and the at least one arrival time or departure time of the at least one other user, then provide the contact information of the at least one other user to the user.

13. The system of claim 12, wherein the personal information is a college or university at which the user and the at least one other user attend school.

14. The system of claim 10, wherein the parking tool is further configured to receive at least one preference of the user, wherein the comparing further comprises comparing the at least one preference of the user to at least one preference of the at least one other user.

15. The system of claim 14, wherein when the at least one preference, the at least one parking structure, and the at least one arrival time or departure time of the user match up with the at least one preference, the at least one parking structure, and the at least one arrival time or departure time of the at least one other user, then provide the contact information of the at least one other user to the user.

16. The system of claim 15, wherein the at least one preference of the user and the at least one other user is a gender preference.

17. A computer program product comprising a computer readable storage medium having readable program code embodied in the storage medium, the computer program product includes at least one component operable to:
receive parking information for a user comprising at least one parking structure and at least one arrival time or departure time of the user at the at least one parking structure;
compare the received at least one parking structure and the at least one arrival time or departure time of the user to parking information of at least one other user comprising at least one parking structure and at least one arrival time or departure time of the at least one other user at the at least one parking structure; and
when the at least one parking structure and the at least one arrival time or departure time of the user match up with the at least one parking structure and the at least one arrival time or departure time of the at least one other user such that the user is either arriving at the at least one parking structure at a time similar to a time at which the at least one other user is departing the at least one parking structure, or the user is departing the at least one parking structure at a time similar to a time at which the at least one other user is arriving at the at least one parking structure, then provide contact information of the at least one other user to the user.

18. The computer program product of claim 17, wherein the at least one component is further operable to receive at least one preference of the user, wherein the comparing further comprises comparing the at least one preference of the user to at least one preference of the at least one other user.

19. The computer program product of claim 18, wherein when the at least one preference, the at least one parking structure, and the at least one arrival time or departure time of the user match up with the at least one preference, the at least one parking structure, and the at least one arrival time or departure time of the at least one other user, then provide the contact information of the at least one other user to the user.

20. The computer program product of claim 19, wherein the at least one preference of the user and the at least one other user is a gender preference.
